(19) United States
(12) Patent Application Publication
(10) Pub. No.: US 2004/0107061 A1
(43) Pub. Date: Jun. 3, 2004

(54) Electronic imaging and quality control method for a fast moving web

(76) Inventor: Hannu Ruuska, Muurame (FI)

Correspondence Address: OSTROLENK FABER GERB & SOFFEN, 1180 AVENUE OF THE AMERICAS, NEW YORK, NY, 100368403

(21) Appl. No.: 10/472,131

(22) PCT Filed: Mar. 13, 2002
(86) PCT No.: PCT/FI02/00196

(30) Foreign Application Priority Data
Mar. 16, 2001 (FI) 20010527
May 29, 2001 (FI) 20011129

(51) Int. Cl. G06F 19/00; G01N 37/00

(52) U.S. Cl. 702/82

(57) ABSTRACT

The invention relates to a method for imaging and analysing the formation and surface topography of a fast-moving web or for the statistical analysis of impurities and spots. An electronic matrix camera is used to take images of a web moving at least 5 m/s, the exposure time of the electronic shutter of the camera being adjusted so that the sum of the static pixel size of the web and the dynamic imaging inaccuracy caused by movement is at most about 0.6 mm in the direction of travel. The exposure time is shorter than 25 μs.

The present invention relates to a matrix imaging method for a fast-moving web using a fast electronic shutter to provide sufficient sharpness of movement.

The field of the invention relates to the quality control and process monitoring of web-like products. A typical web being monitored could be, for example, paper, board, non-woven fabric or fibreglass wallpaper. The problem now solved relates to the imaging of a fast-moving web in real time for the needs of production and/or quality control. In the case of the present invention, such needs are statistical calculation of impurities and spots or topographic surface imaging and analysis.

It is desirable to image the web during production because imaging is an efficient method of quality control. The desired imaging methods are usually background-lit imaging, or imaging utilising surface reflection. By means of background lighting or surface reflection, impurities and spots in the material being manufactured, for example, paper can be imaged. Between the web and a light source may be used a diffuser, by means of which the light distribution can be equalised and a desired directional distribution of the rays be obtained. Reflected light, that is, illumination from the face of the web provides information especially on the visual quality of the surface, such as the surface topography.

In addition to mere visual patterning, mathematical analysis is usually used for image analysis, especially frequency analysis utilising Fourier transformations or similar functional transformations. In this way is obtained information on the statistical incidence of impurities and spots and/or the surface topography. What is essential for mathematical analysis is sufficient two-dimensional accuracy of imaging.

Known imaging technology is represented by line cameras having an imaging speed of around 40 000 lines per second. In addition has been used a laser beam with a 0,1 mm diameter, from the intensity variations of the penetrated or reflected light of which is collected the required information by means of frequency analysis. However, this does not provide information in the lateral direction of the web on more than the area of one pixel, and thus the image cannot be used for two-dimensional analysis or imaging.

It is not possible by means of an ordinary video camera to obtain a sufficiently accurate image of a web moving, for example, 25 metres per second, because it moves too much during the exposure time. Electronic cameras with shutters have not functioned in real time imaging of fast webs. Even the shortest exposure times of cameras have been too long for this purpose, up until recently typically about 1/10000of a second. When the speed of the web is, for example, 25 metres per second, it has moved about 2.5 mm during an exposure time of 1/10000of a second. This means that the maximum accuracy in the direction of travel is 2.5 mm. Since the maximum inaccuracy allowed for an image used for analysis or monitoring is at most about 1 mm, typically about 0.5-0.6 mm, until now it has not been possible to use electronic matrix cameras for imaging at sufficient accuracy.

In the method relating to the invention, the requirement for sufficient accuracy in the direction of travel needed for imaging is solved by using an extremely fast electronic shutter as the camera shutter. The shortest exposure times of new commercial shutters which have just become available are typically of the order of 1/100000of a second, and thus a web travelling at 25 m/s will only have time to move about 0.25 mm during the exposure time. Let us assume that, in an example case, the size of the pixel of the camera is 0.25 mm. Because image accuracy can be roughly approximated as the sum of the size of the pixel and the inaccuracy resulting from movement, in this case the required image accuracy of 0.5 mm is obtained with a pixel size of 0.25 mm.

The characteristics of the invention are disclosed in the accompanying claims.

The method relating to the invention is illustrated in the following by means of the accompanying diagrammatic plans:

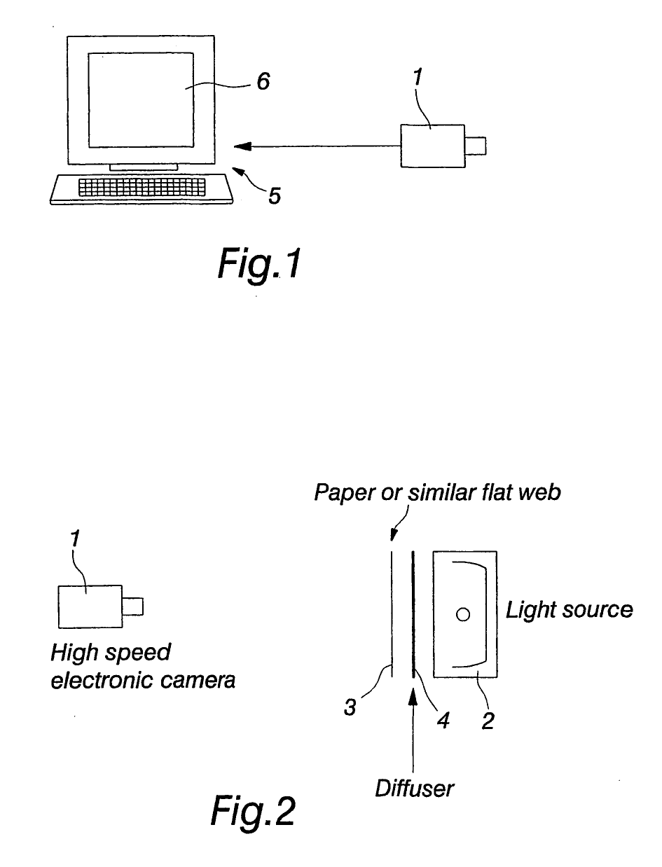

FIG. 1 shows the connection of a camera 1 to a computer 5 used for analysis and/or statistical calculation and its display 6.

FIG. 2 shows an arrangement according to the invention when using penetrated light, in which case the light source 2 is on a different side of the web 3 than the camera 1. If diffuse lighting is desired, a diffuser 4 is additionally used.

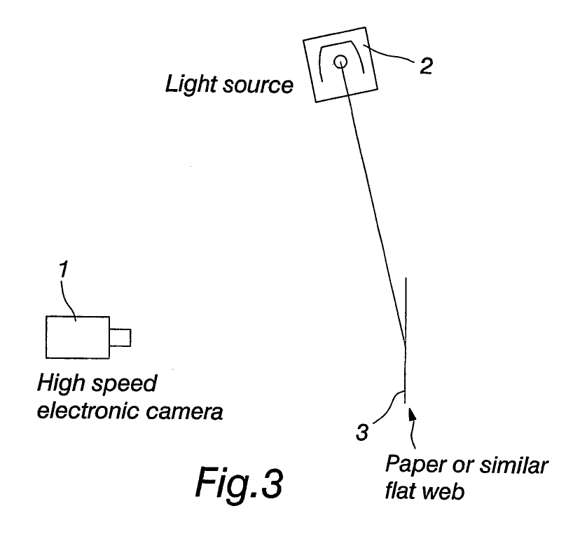

FIG. 3 shows an arrangement according to the invention where surface topography is imaged using reflected light. The light source 2 is on the same side of the web 3 as the camera 1, positioned in such a way that the light arrives on the surface of the web 3 deviating approximately 5-15, preferably 5-10 degrees from the direction of the surface.

In the examples shown in the Figures, a camera 1 provided with a fast electronic shutter is fitted for imaging the web 3. An exposure time of, for example, 1/100000of a second may preferably be used, which will still give a sufficiently sharp image of a web travelling at a speed exceeding 25 m/s. The minimum for the exposure time is about 25 μs, in which case a sufficiently sharp image for the purpose of the invention is obtained even of a web travelling at a speed as high as 5 m/s. The repetition speed of imaging may be adjusted as desired so as to be sufficient for monitoring the process. For mathematical calculation, images can also be taken more rapidly than can momentarily be processed, the maximum speed being the highest speed of the camera, data transfer used for transmitting the images, and the recording medium used. The repetition speed of the image monitored by the operator may be selected so as to be agreeable to monitor.

The preferable size of the pixel used is not much smaller than the reduction in accuracy caused by movement. In practice this means that the distance travelled by the web during the exposure time is at most of the same order of magnitude with the dimension of the pixel in the direction of travel. This is to ensure sufficient accuracy so that potential information is not lost. If the pixel selected is much smaller than the blurring caused by the movement, all the information available cannot be used efficiently. It should be noted that with the exception of blurring due to movement, with a matrix camera a similar image can also be taken of a web at rest. Known line camera applications require a moving web. Using a matrix camera with a fast shutter is advantageous also with conventional web speeds because of the more versatile possibilities of analysis offered by it, typically in the analysis of webs travelling at least at 5 m/s.

The image information is typically post-processed by known signal processing methods, by means of which impurities and spots can be statistically calculated or information on the surface topography be obtained. In topographic imaging of surfaces, the light must arrive on the surface deviating only about 5 to 10 degrees from the direction of the surface (FIG. 3). In such a case, in accordance with the topography, each protrusion wall directed at the light will be better illuminated than surfaces descending away from the light. The camera then receives information on the surface topography on the basis of variations in lightness/darkness.

The machine operator's image may be either the camera image as such or a digitally processed image with which desired information can be emphasised. Images may obviously also be stored for more long-term monitoring and analysis of the process.

The camera or cameras and lighting equipment can be fixed at a fixed point close to the web, or they may be fixed to a measuring carriage moving transversely across the web. Similarly, the measurement can be carried out at several points on the web in the transverse and machine directions.

The image field on the surface of the web may be, for example, 150 mm in the machine direction and 200 mm in the transverse direction. The size of the pixels may be, for example, 0.25 ×0.25 mm. With slow web process machines the exposure time is, for example, 1/40000of a second or less. With fast machines, where the speed of travel of the web is over 20 m/s, for example, about 25 m/s or more, the exposure time is under 1/80000of a second, for example 1/100000of a second or less.

The illumination of the web for the purpose of calculating the impurities and spots can be carried out either as transillumination or surface reflection. In this case illumination by surface reflection must be done much more perpendicularly to the plane of the web than in the case of FIG. 3. Transillumination is used for calculating the pinholes (number/area). Even a small pinhole will create a strong flash inside the pixel.

The calculation of impurities and spots is performed in accordance with the TAPPI norms (Technical Association of Pulp and Paper Industry), that is, the impurities and spots are first divided into size categories (3-7 size categories) and then the absolute number per area in each size category is determined. This also gives the area of the impurities and spots as a percentage of the overall area.

1. A method for imaging a fast-moving web for the purpose of imaging and analysing the surface topography, or for the statistical calculation of impurities and spots, characterised in that for image formation is used a matrix camera so that the image exposure time is shorter than 25 μs.

2. A method as claimed in claim 1 for the statistical calculation of impurities and spots, characterised in that with the camera is taken a freeze-frame by using transillumination of the web or surface reflection.

3. A method as claimed in claim 1 for imaging and analysing of web surface topography, characterised in that with the camera is taken a freeze-frame by using surface reflection, where the reflecting light arrives on the surface deviating approximately 5-15, preferably 5-10 degrees from the direction of the surface.

4. A method as claimed in any of the claims 1 to 3, characterised in that the matrix camera is used to take images of a web moving at least 5 m/s, and the exposure time of the electronic shutter of the camera is adjusted so that the sum of the static pixel size of the web and the dynamic imaging inaccuracy caused by movement is at most about 0.6 mm in the direction of travel.

5. A method as claimed in claim 4, characterised in that the static accuracy of the pixel is at least of the same order of magnitude as the dynamic accuracy, that is, that the distance travelled by the web during the exposure time is at most of the same order of magnitude as the dimension of the pixel in the direction of travel.

6. A method as claimed in claim 4 or 5, characterised in that the speed of travel of the web is over 20 m/s and the exposure time under 1/80000of a second.
